(19) United States
(12) Patent Application Publication
(10) Pub. No.: US 2004/0058203 A1
(43) Pub. Date: Mar. 25, 2004

(54) Mixed reactant fuel cells

(76) Inventors: Michael Alexander Priestnall, Cambridge (GB); Michael Joseph Evans, Cambridge (GB); Milo Sebastian Peter Shaffer, London (GB)

Correspondence Address: BRUCE E. LILLING, LILLING & LILLING P.C., P.O. BOX 560, GOLDEN BRIDGE, NY, 10526, US

(21) Appl. No.: 10/239,348

(22) PCT Filed: Mar. 26, 2001
(86) PCT No.: PCT/GB01/01322

(30) Foreign Application Priority Data
Mar. 24, 2000 (GB) 0007306.4

(51) Int. Cl. H01M 8/00; H01M 6/00; H01M 10/00

(52) U.S. Cl. 429/12; 429/122

(57) ABSTRACT

A fuel cell or battery for providing useful electrical power by electrochemical means, comprises: at least one cell; at least one anode and at least one cathode within said cell, and ion-conducting electrolyte means for transporting ions between the electrodes; characterised in that: fuel, oxidant and said electrolyte means are present as a mixture.

The present invention relates to electrochemical systems and, in particular, to fuel cells or batteries using mixed reactants, that is to say reactants which are in direct contact with each other within a fuel cell or battery.

Generally, it will be understood by persons skilled in the art that the term “fuel cell” denotes a power generating electrochemical device to which reactants (fuel plus oxidant) are fed to meet demand. The term “battery” will be generally understood to mean a power generating electrochemical system that is self-contained and which receives no continual feed of reactants to meet demand, but which can become electrochemically depleted. Batteries may, of course, be replenished by electrical charging. It is not the purpose of this document to provide new definitions of “fuel cell” and “battery”, but it is within the scope of the present invention for a battery to have mobile or mobilisable reactants contained within it.

A conventional fuel cell or battery consists of two electrodes sandwiched around an electrolyte which serves to keep the chemical reactants physically separated from each other. In one common type of fuel cell the reactants are hydrogen and oxygen. Oxygen passes over one electrode and hydrogen over the other, generating electricity, water and heat. In such a type of fuel cell, hydrogen fuel is fed to the anode of the fuel cell.

Oxygen, or air, is fed to the fuel cell in the region of the cathode. At the anode, hydrogen atoms are split into protons and electrons, usually with the assistance of a catalyst. The protons pass through the electrolyte, which is an ionic conductor but which has a very high resistance to passage of electrons and can therefore be regarded as an electronic insulator. The electrons therefore take an external path to the cathode and can be passed through a load to perform useful work before reaching the cathode. At the cathode, protons that have migrated through the electrolyte are combined with oxygen and electrons to form water.

Since fuel cells rely on electrochemistry rather than thermal combustion for useful energy conversion, operating temperatures and conversion efficiencies are higher so that emissions from fuel cell systems are very much smaller than emissions from even the cleanest fuel combustion systems. These are two reasons why fuel cells are attractive. However, the current high cost of fuel cells is outweighed by the relatively cheap cost of producing electricity by combustion. Although fuel cells offer additional advantages such as low noise and wide load capability, the major effort in current fuel cell technology is aimed at developing cheaper systems that compete with conventional power-generating systems on the basis of cost, weight and volume.

The majority of work reported in fuel cell technology is based on conventional arrangements as described above in which separate feeds of fuel and oxidant are delivered to different compartments of the fuel cell. However, a very small minority of workers have investigated the possibilities, the majority of which are described below, of using mixed reactants. Although direct reaction between mixed reactants is thermodynamically favourable, it can be effectively suppressed or prevented for a number of reasons, which can be exploited by the cell designer: For example, reaction may be effectively prevented by a high activation energy for the direct reaction and/or by slow kinetics for the reaction and/or by slow diffusion of species. By adopting selectively catalytic electrodes or other selective approaches, a reduction reaction can be promoted at the cathode and an oxidation reaction at the anode, whilst the degree of possible reaction in the reactant mixture is negligible.

Early work in the field of mixed reactant fuel cells was reported by Charles Eyraud, Janine Lenoir and Michel Géry in Seance, 13 March 1961. The single cell reported in this document uses a porous alumina membrane having water molecules adsorbed thereon which, under certain conditions of temperature and pressure, can be made to act as a film electrolyte. The cathode is a porous metal sheet of copper or nickel, for example. The anode is a vacuum-deposited layer of platinum or palladium. It is reported that, in humid air (i.e. no fuel), the oxidation of the nickel manifests itself in a potential difference across the electrodes of a porous Ni—Al₂O₃—Pd element.

With fuel incorporated in the feed gas mixture, the performance of this arrangement is limited by the diffusion characteristics of the fuel and oxidant mixture through the porous alumina element. The addition of an ionisable constituent such as ammonia into the alumina or into the gaseous mixture as a means of enhancing the ionic conductivity of the fixed water film electrolyte adsorbed in the porous alumina was contemplated. None of these concepts seem to have been developed into a worthwhile product.

C. K. Dyer in Nature, Volume 343, (1990), pages 547-548, describes a thin-film electrochemical device for energy conversion. Dyer's device is a solid electrolyte fuel cell capable of operating with a mixture of an oxidant and a fuel. It includes a permeable catalytic electrode and an impermeable catalytic electrode, the two electrodes being separated by an electron insulating but ion-conducting, gas permeable solid electrolyte. This solid electrolyte fuel cell operates on a gas fuel/oxidant mixture. The mixture is supplied to only one electrode and diffuses to the other electrode through the porous electrolyte. A concentration gradient is established through differential diffusional migration through the solid electrolyte. The device is described in single cell form only.

Moseley and Williams in Nature, Volume 346, (1990), page 23, report use of Au/Pt electrodes in a sensor device for sensing reducing gases. In their system, atmospheric water adsorption on the surface of a substrate separating the electrodes acts as a fixed film electrolyte. They also claim that the platinum electrode can support electrochemical combustion of a target gas such as carbon monoxide. Their device exhibits the convenient attributes of operating at room temperature and functioning without the need to separate the analyte (fuel) gas from the oxidant. It is emphasised that this device operates as a sensor and its use for power generation was not contemplated.

W. van Gool in Philips Res. Repts., Volume 20, (1965), pages 81 to 93, discusses the possible use of surface migration in fuel cells and heterogeneous catalysis. In one disclosed arrangement, both electrodes are in contact with a mixture of fuel gas and oxygen, ions migrate across a substrate surface between the electrodes and selective chemisorption is used to achieve separation. This type of fuel cell arrangement is inherently unsuitable for power generation because of the high resistance afforded by the electrolyte geometry and is generally applicable only to sensor applications. Selective electrodes, particularly operating by selective chemisorption, are seen as useful in this type of fuel cell arrangement.

A review of solid oxide fuel cells operating on uniform mixtures of fuel and air appears in Solid State Ionics, Volume 82, (1995), pages 1-4.

Hibino and Iwahara describe a simplified solid oxide fuel cell system using partial oxidation of methane in Chemistry Letters, (1993), pages 1131-1134. An alternative fuel cell system is proposed which works at high temperatures and uses a methane plus air mixture as an energy source. A Y₂O₃-doped zirconia (YSZ) disc is used as a solid electrolyte. A nickel-YSZ cermet (80:20 wt %) was sintered on one surface of the solid electrolyte disc at 1400° C., and then Au metal was applied to the other face of the solid electrolyte disc at 900° C. These electrodes are reported to be sufficiently porous to allow the ambient fuel plus air mixture to diffuse through them. Early designs based on this system were acknowledged as being unsatisfactory in terms of electrical power output.

More recently (Science, Volume 288, (2000), pages 2031-2033), Hibino has reported a low-operating temperature solid oxide fuel cell using a hydrocarbon-air mixture but using samaria-doped ceria (SDC) as the solid electrolyte. SDC is reported to have a much higher ionic conduction than YSZ in an oxidising atmosphere. Also, this system uses no precious metals in the electrodes, so fabrication costs are relatively low.

In similar vein, Gödickemeier et al. report in the Proceedings of 192nd Meeting of Electrochem. Soc. and the 48th Meeting of the Int. Soc. of Electrochem—Paris, France, 1997, solid oxide fuel cells with reaction-selective electrodes. They report an arrangement in which solid oxide fuel cells are operated in uniform mixtures of fuel gas and air. The voltage is generated between an anode which is selective for the oxidation of the fuel and a cathode on which only the reduction of oxygen can occur. In the case where the fuel gas is methane, the cathode is inert to the combustion of methane.

In Fuel Cells, Modern Processes for the Electrochemical Production of Energy, Wolf Vielstich, Institute für Physikalische Chemie der Universitat Bonn (Translated by D. J. G. Ives, Birkbeck College, University of London, Wiley-Interscience ISBN 0 471 906956), a cell is described on pages 374 and 375 as being a radiolytically regenerated oxyhydrogen cell. Water is decomposed to hydrogen and oxygen by means of a chemical nuclear reactor. The product gas, a mixture of hydrogen and oxygen, is fed to an electrolytic cell comprising two gas-diffusion electrodes. The mixed fuel gas is first introduced to the cathode side of the cell and the oxygen concentration is decreased as a result of selective reaction. The residual gas, rich in hydrogen, is then fed to the anode side of the cell. In this arrangement, the utilisation of the mixed fuel occurs in a two-step process. A liquid electrolyte is constrained between the electrodes, while the reactant gases are supplied to the external surfaces of the electrodes.

Zhu et al, Journal of Power Sources, Volume 79, (1999), pages 30-36, describes so-called “non-conventional” fuel cell systems, including single chamber systems operating on mixed reactants. A conventional solid electrolyte is used and doping is discussed as a means of tailoring the electrical conductivity and other properties of the electrolyte and/or electrodes to obtain the required function.

One of the key advantages that can be attributed to each of the mixed reactant systems discussed above is that use of mixed reactants allows complex manifolding to be eliminated. There is no longer any need for convoluted passages to be constructed to deliver the separate fuel and oxidant feeds to respective chambers in the fuel cell. Hence, the problematic sealing requirements of the fuel cell are eased. Additionally, an arrangement with lessened sealing demands and no manifolding is not so wasteful of space as a conventional fuel cell. An infrastructure is still required to move fuel plus oxidant from one place to another within or across the cell but, generally speaking, use of a mixed reactant system allows greater versatility in cell design. The mixed reactant technology can be applied to gas mixtures generated from radiolytic, electrolytic or photolytic systems. An example of a system exploiting spent gas generated radiolytically is discussed above.

The disadvantages of mixed reactant fuel cells compared to their conventional counterparts are that they generally deliver lower performance in terms of fuel efficiency and cell voltage (parasitic fuel-oxidant reactions). Problems associated with parasitic reactions could be overcome by development of better selective electrodes. With conventional electrode materials, the efficiency of mixed reactant fuel cells will be inferior to that of a conventional system in which the fuel and oxidant are maintained in separate feeds. However, other performance measures such as cost and power density may be significantly enhanced. A concern with mixed reactant fuel cells is that certain reactant mixtures have an attendant risk of explosion. However as discussed above, mixed reactants do not necessarily undergo reaction simply because it is thermodynamically favourable.

Another limitation of known fuel cells is that electrochemical reaction only occurs at an interface between three phases. In other words, electrochemical reaction is limited to sites on the catalyst where reactant and electrolyte meet together. This latter problem is not only a limitation in mixed reactant fuel cells, but is also a disadvantage of conventional fuel cells.

It is therefore an object of the present invention to provide a fuel cell or battery that ameliorates the disadvantages outlined above. In particular, it is an object of the present invention to provide a fuel cell or battery that eliminates complex manifolding and reduces problems associated with providing effective sealing. It is also an object of the present invention to provide a fuel cell or battery that makes more effective use of the space it occupies. It is yet another object of the present invention to provide a fuel cell or battery that is versatile in its use or applicability and which has the capability of using mixed fuel and oxidant as reactants that are readily available from the environment, or which has the capability to use gases produced in radiolytic, electrolytic or photolytic systems. It is a still further object of the present invention to compensate for less than perfect utilisation of fuel by boosting overall performance. It is yet another object of the present invention to provide a fuel cell or battery that is capable of delivering high power levels on demand.

In a first aspect, the invention is a fuel cell or battery for providing useful electrical power by electrochemical means, comprising:

at least one cell;

at least one anode and at least one cathode within said cell, and ion-conducting electrolyte means for transporting ions between the electrodes;

characterised in that:

fuel, oxidant and said electrolyte means are present as a mixture.

It is important that the fuel/oxidant/electrolyte means is present in a mixed form. Preferably, the mixture is a fluid, which term is used to include liquids, gases, solutions and even plasmas. The mixture may be solid or immobilised. For example, the mixture may be optionally gelled or otherwise bound to or contained in a matrix. The components of the mixture preferably have high diffusivity within each other.

Most preferably, the fuel will be an oxidisable component in fluid form (as defined above). Oxidisable is used to denote that the fuel can donate electrons to form an alternative oxidation state. Examples of suitable fuels include hydrogen, hydrocarbons such as methane and propane, C₁-C₄ alcohols, especially methanol and/or ethanol, sodium borohydride, ammonia, hydrazine and metal salts in molten or dissolved form.

Most preferably, the oxidant is a reducible component in fluid form. That is to say, the oxidant behaves as an electron acceptor. Examples of suitable oxidant materials include oxygen air, hydrogen peroxide, metal salts—especially metal salts containing oxygen such as chromate, vanadate, manganate or the like, and acids. The oxygen may be present in dissolved form, for example as dissolved oxygen in water, acid solution or dissolved in perfluorocarbon.

The electrolyte will also be a component in fluid form and has ionic/electronic transport capabilities such that it conducts ions in preference to electrons. Suitable materials for the electrolyte include acidified perfluorocarbons, plasma, aqueous systems, water, molten salts, acids and alkalis.

It is possible that the fuel or oxidant can create or behave as an electrolyte. In other words, the electrolyte does not have to be a discrete component in the mixture. Similarly, neither do the fuel and oxidant have to be discrete components in the mixture. However, it is vital that the mixture has triple functionality in that the functions of oxidant, fuel and electrolyte must be attributable to it.

The term “electrode” in this document will be understood as including electrocatalysts and an electronically conducting medium into or onto which the electrocatalyst is incorporated, or which is the electrocatalyst itself.

The key advantage that the present invention has over conventional fuel cells, as well as over mixed reactant systems of the types described above, is that the incorporation of electrolyte functionality in the reactant mixture vastly increases the effective active surface at the electrode. Conventionally, the way of increasing the active surface area of an electrode has been to provide increasingly small electrocatalyst particles. By causing the reactant mixture with its triple functionality to pass through the body of a porous electrode, the present invention effectively maximises the active surface of the electrode.

Also, conventional solid electrolytes are expensive and the present invention therefore allows one of the costly parts of the fuel cell to be omitted. Hence, manufacturing costs can be decreased. Furthermore, the solid electrolyte employed in conventional fuel cells requires careful water management. Hydrated polymeric electrolyte membranes are, for example, susceptible to drying out or flooding if the water management is not optimised. Fluid electrolytes generally have higher conductivity than solid electrolytes. Additionally, fluid electrolytes can be agitated to enhance ionic transport still further. Thus, it can be seen that there are many advantages in constructing a fuel cell which dispenses with the traditional electrolyte and its attendant shortcomings.

Another advantage is that it may be possible to make use of environmental products that already comprise a mixture of fuel plus oxidant, for example land-fill gas comprising methane plus air.

Although mass transport will be limited in non-fluid systems, it is recognised that some applications for the fuel cells according to the present invention will benefit from using a constrained mixture. For example, in the field of miniature fuel cells and/or solid state fuel cells that are intended for use as battery replacements, replenishment of the mixture as a cartridge/cassette or other readily-manipulated form would be advantageous. Such replenishment could be akin to replacing an exhausted ink cartridge in a printer apparatus or the like, or to refuelling a cigarette lighter or heated hair curling tongs.

Replenishment of the fuel cell or battery is not restricted to the example given above which describes replenishment of the mixture by physical means. Replenishment of the mixture could alternatively be by thermal, chemical or electrical means. It is also within the scope of the present invention for individual constituents of the mixture to be regenerated or renewed. Such replenishment may be by physical, thermal, chemical or electrical means.

The operating temperature range of fuel cells in accordance with the present invention may be from 0° C. up to 1000° C. or higher. Those systems which use a plasma component in the mixture will be difficult to categorise in terms of operating temperature because it is difficult to measure plasma temperatures.

The fuel cell or battery according to the present invention may include means, such as baffles or a stirrer, for generating turbulence within the system to enhance species transport to and from the electrodes. One or more of the electrodes may be capable of adsorbing or otherwise storing either fuel or oxidant species.

Preferably, a high activation energy for reaction between the reactants is utilised to provide stability against self-discharge of the fuel cell or battery.

Alternatively, or in addition, slow kinetics for reaction between the reactants can be utilised to provide stability against self-discharge. Also, slow kinetics for diffusion of the reactants can be utilised to provide stability against self-discharge.

An oxygen-carrying liquid (such as a perfluorocarbon) may be used to dissolve oxygen or to co-dissolve fuel and oxygen. The oxidant component of the fuel cell or battery may then be recharged by dissolution of a gas (such as oxygen) in a suitable liquid, such as a perfluorocarbon.

The present invention also contemplates a fuel cell or battery operating on a single supply of a stable combination of reactants that are or are contained in immiscible or partially immiscible phases. An example of such an arrangement would be a reactant/electrolyte means mixture comprised of a stable emulsion. The fuel cell or battery according to the present invention may operate on a single supply of a combination of reactants that are or are contained in immiscible or partially immiscible phases which spontaneously segregate within the device. Alternatively, the fuel cell or battery may operate on separate supplies of oxidant and reductant that are or are contained in immiscible or partially immiscible phases that nevertheless come into contact within the device in the presence of electrolyte means which may, optionally, be combined with at least one of the separate supplies of oxidant and reductant. As previously mentioned, the oxidant and/or reductant may have electrolyte functionality so that a separate electrolyte component is not required.

Turbulence can be used to increase the contact between the immiscible or partially immiscible phases.

Preferably, the electrolyte is present to an appreciable degree in both phases because, as discussed above, the electrochemical reaction can only occur at the three-phase catalyst/electrolyte/reactant interface. Hence, if one of the immiscible or partially immiscible phases is electrolyte deficient, the opportunities for electrochemical reaction will be limited and the performance of the fuel cell or battery will be compromised. Again, turbulence can be used to increase the surface area of contact between an electrolyte deficient phase and an electrolyte rich phase and the relevant cell electrode. The fuel cell or battery according to the present invention may utilise the electrode materials both as a surface for the primary cell reactions and as reactants for secondary cell reactions which provide the cell with additional output voltage and/or higher inherent energy density. The fuel cell or battery according to the present invention may also utilise the NEMCA (Non-faradaic Electrochemical Modification of Catalytic Activity) or similar effects to enhance the stability of the mixture when the device is not generating electricity. The NEMCA effect is a recognition that the activity of an electrocatalyst is modified by its surface charge.

The fuel cell or battery according to the present invention may include a supply of reactants containing a component capable of disproportionation. Such a system may optionally be rechargeable. For example, the reactant may include carbon monoxide which disproportionates to carbon and carbon dioxide, which can be regenerated to carbon monoxide by heating. Another example is a solution of manganese ions, in which the disproportionating component is also the electrolyte.

In a second aspect the invention is a fuel cell or battery for providing useful electrical power by electrochemical means, comprising:

at least one cell;

at least one anode and at least one cathode within said cell, and

an alkaline electrolyte for transporting ions between the electrodes;

characterised in that:

fuel, oxidant and said electrolyte means are present as a mixture, and in that said fuel is carbon or a carbonaceous species.

Hitherto, it has been thought that it is not possible to operate a low temperature fuel cell, such as those based on proton exchange membranes or alkaline electrolytes, with a conventional platinum anode catalyst in the presence of certain carbonaceous species because the species will rapidly poison the platinum catalyst and severely degrade its performance. However, in accordance with the present invention, it has now proved possible to operate an alkaline fuel cell directly on a hydrocarbon fuel, such as methanol, or a CO/CO₂-containing fuel with a simple platinum catalyst anode for extended periods without significant degradation provided that electrolyte concentration is maintained. Without wishing to be bound by theory, it is believed that the mechanism which allows such operation without poisoning of the platinum catalyst is the effective scrubbing of the carbonaceous species by the electrolyte. The advantage brought to this concept by the present invention is that the electrolyte forms part of the fuel/oxidant/electrolyte mixture and is therefore fed to the cell at concentrations which permit continuous operation without catalyst poisoning.

In addition, the continuous introduction of an oxidant, such as air, allows operation of such an alkaline fuel cell to be maintained when an air cathode (typically based on manganese on nickel) is immersed directly in the mixture of liquid, fuel and alkaline electrolyte solution.

In a third aspect the invention is a fuel cell or battery for providing useful electrical power by electrochemical means, comprising:

at least one cell;

at least one anode and at least one cathode within said cell, and

ion-conducting electrolyte means for transporting ions between the electrodes;

characterised in that:

fuel, oxidant and said electrolyte means are present as a mixture and in that said electrodes have electrocatalysts associated therewith which are selective by virtue of their electric potential.

The phenomenon whereby catalysts can be rendered selective by virtue of their electric potential rather than, or in addition to, their chemical or physical nature is well-known as the NEMCA (Non-faradaic Electrochemical Modification of Catalytic Activity) effect. The invention uses the same NEMCA catalyst for both anode and cathode in a single chamber fuel cell. When at a relatively positive potential, the catalyst favours the reduction reaction, whilst at a relatively negative potential it favours the oxidation reaction. Once the fuel cell is operating, the electrochemical reactions will tend to maintain the bias on the respective electrodes, and hence their selectivity. The bias may be established initially through positive feedback of a random instability, or by brief application of an external potential.

The advantage of this arrangement is that the polarity may be reversed during operation, by the brief application of an external potential, such that the anode becomes the cathode and vice versa. The external potential may be applied, for example, by an external power source, or by use of a capacitor charged by the fuel cell itself. The benefit is that the performance of the fuel cell can be significantly improved, which is manifested as higher current density, cell voltage and improved fuel utilisation.

Currently fuel cells are subject to two disadvantages which affect their performance that can be overcome by this aspect of the present invention. Firstly, reactants become depleted near the electrodes. Secondly, catalysts become poisoned during operation, such that their initial performance is reduced very significantly after current has been flowing a relatively short time, perhaps as little as a few minutes. Reversing the polarity of the fuel cell on a regular basis can relieve both of the above problems and yield improved current and voltage characteristics by reducing power losses due to cell polarisation.

Under normal operation in any fuel cell, fuel locally present at the anode is oxidised while oxidant locally present at the cathode is reduced, causing both these reactant species to become depleted at their respective electrodes, with resultant cell performance degradation over time. In a mixed reactant fuel cell as described in this specification, as well as the foregoing processes, non-reacting oxidant will be locally present at the anode and may possibly build up. Similarly, there will be non-reacting fuel present at the cathode which may also accumulate. However, as soon as a reversal of polarity is imposed, these local concentrations of fuel and oxidant are able to engage in the electrochemical reaction, thereby significantly improving instantaneous cell performance. Simultaneously, i.e. as soon as electrode polarity has been reversed, the local concentration of previously depleted reactant is provided with an opportunity to recover. By regularly switching electrode polarity at an optimum rate suited to the geometry and nature of the mixed reactant cell, it is possible to maintain an overall cell performance that approaches its peak instantaneous performance.

There are three main applications for fuel cells or batteries in accordance with the present invention. Firstly, they may be used in automotive applications, ultimately for installation on board vehicles to replace internal combustion engines. Already, some hybrid systems are in practical use, where an engine burning fossil fuel is supplemented by a fuel cell. Typically, hydrogen fuel cells are used—the hydrogen may be stored on board the vehicle or may be formed by a reformer. A liquid fuel such as methanol could be used instead to feed a mixed reactant system as described here. This has the advantage of delivering a higher peak current. Currently, however, fuel cells are unable to compete with internal combustion engines in terms of cost per unit power. Typically, for an internal combustion engine, the power costs $30 to $40 per kW. Size considerations must also be taken into account, since fuel cells are unlikely to be adopted as internal combustion engine replacements if bulky fuel storage and fluid management systems are required that occupy more space than current arrangements.

Another application for fuel cells in accordance with the present invention will be for stationary systems, such as combined heat and power generation. Infrastructure already exists for distributing power generated centrally, but distributed heat is relatively rare. One advantage of fuel cells is that they are equally efficient when scaled down, so they have potential for use in residential applications for generating heat and power in combination.

Another application for fuel cells according to the present invention is for replacement or support of conventional batteries. As discussed above, fuel cells in accordance with the present invention can be recharged mechanically rather than chemically or electrically, so this makes replenishment very quick. Also, the energy density of a system based on methanol, for example, is superior to that of conventional batteries and great potential is therefore seen for the application of fuel cells to portable electronics. This is particularly true when the manifolding requirement is removed, because the fuel cell can be made more compact. Also the oxidant is in the system so there is no need for an air electrode or exposure to air. Thus water management problems such as the drying out of the electrodes is thereby avoided.

The invention will now be particularly described by way of example only with reference to the drawings, in which:

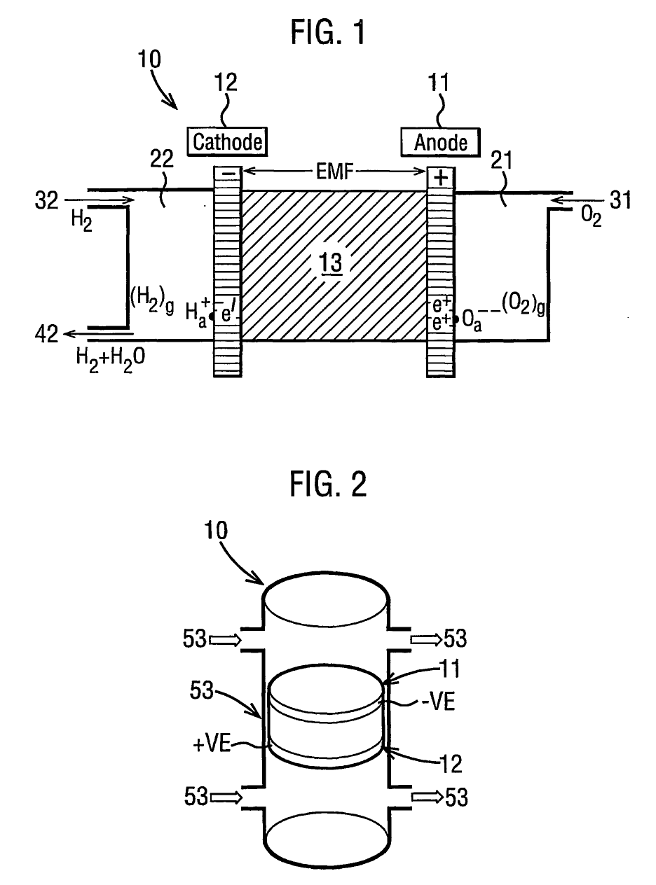

FIG. 1 is a schematic diagram of a conventional fuel cell;

FIG. 2 is a schematic perspective view of a fuel cell in accordance with a first aspect of the present invention;

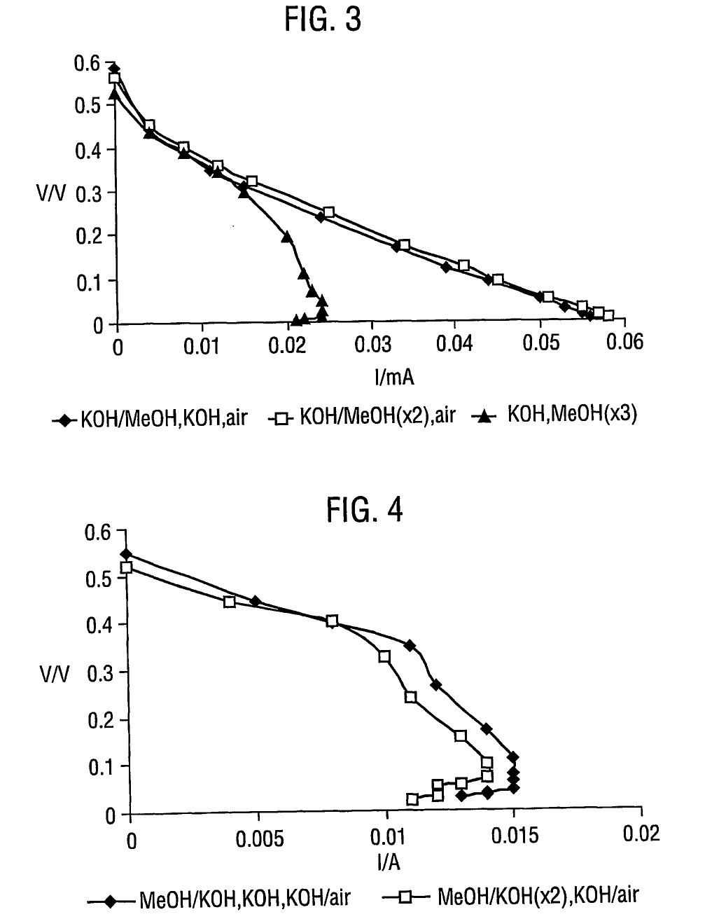

FIG. 3 is a graph showing curves of voltage against current for a prototype three-chamber cell having the electrodes spaced 4 cm apart;

FIG. 4 is a graph of voltage against current comparing fuel cells using dissolved oxygen;

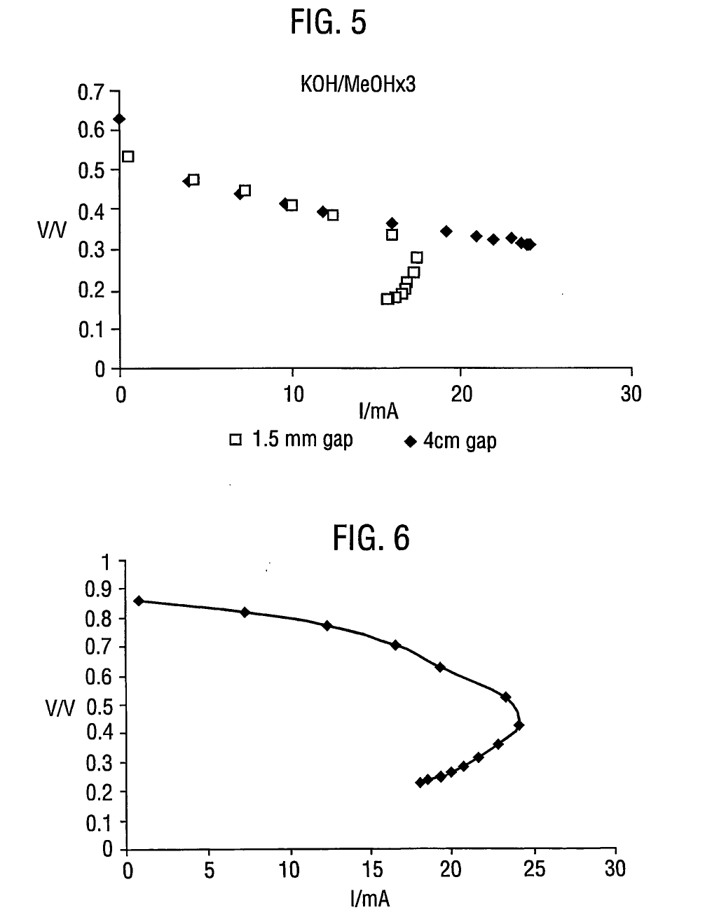

FIG. 5 is a plot showing the variation in performance with different electrode spacings;

FIG. 6 is a curve of voltage against current for a prototype stack of five anodes and cathodes;

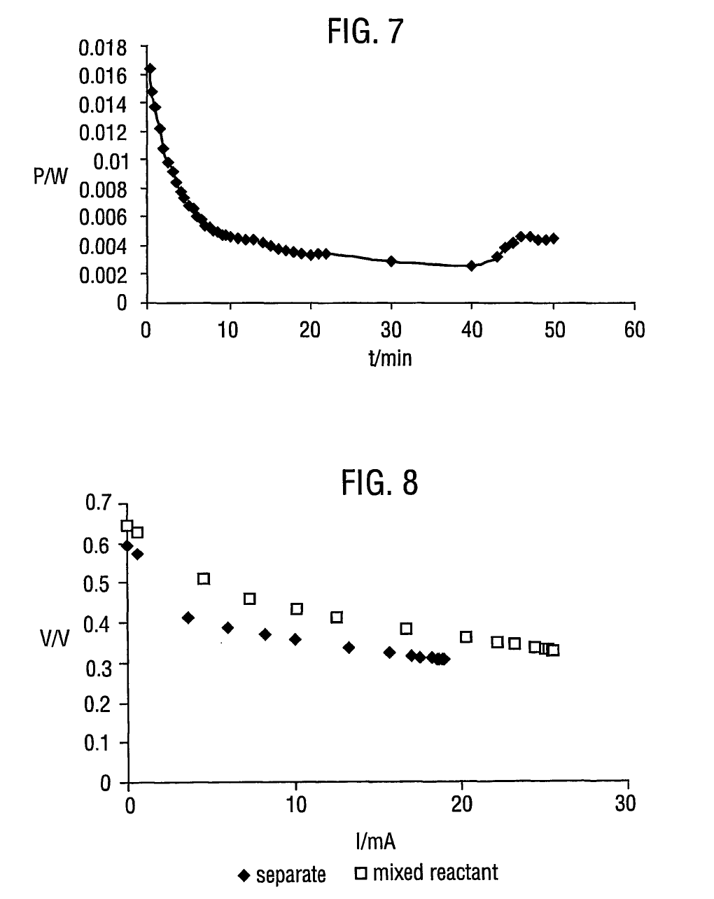

FIG. 7 is a plot of the power produced against time for an alternative stack, and

FIG. 8 is a graph comparing performance between a conventional fuel cell and a fuel cell constructed in accordance with the present invention.

Referring firstly to FIG. 1, this shows schematically an arrangement for a conventional fuel cell 10, comprising an anode 11 and a cathode 12 separated by an electrolyte medium 13 which permits passage of ions but which prohibits transfer of electrons. External to the chamber containing the electrolyte medium 13 are respective anode and cathode gas spaces 21, 22. Anode gas space 21 has an inlet 31 for receiving a feed stream of an oxidant, such as oxygen. Cathode gas space 22 has an inlet 32 for receiving a feed stream of a fuel, such as hydrogen, and an outlet 42 for removing unused fuel and by-products of the electrochemical reaction.

The respective gas spaces and feed streams must be isolated from each other and, although it is not clear from the schematic representation of FIG. 1, a fuel cell assembly constructed according to conventional principles can involve complex and convoluted manifolding. The sealing requirements are demanding and much potentially useful space is occupied by components that do not contribute to the power output of the cell.

### EXPERIMENTAL

Experiments were conducted using alkaline fuel cells. Current-voltage plots were obtained for fuel cells using methanol or sodium borohydride as fuel, potassium hydroxide as the electrolyte, and both gaseous and dissolved oxygen as the oxidant. The mixed reactant concept was tested in both static and in flow-through modes and in comparison against a ‘conventional’ separate reactant fuel cell mode.

The conventional cell, chosen as a control, was selected for ease of comparison with the fuel cell according to the present invention. The performance of the conventional cell, being a form of direct methanol cell, was very modest compared to the best gaseous-fuelled polymer electrolyte membrane fuel cells, but in keeping with the unoptimised design of the new mixed-reactant fuel cell.

Surprisingly, the mixed reactant cell gave out slightly more power than the conventional separate reaction cell. This was attributed to having fuel on both sides of the anode and to using oxygen dissolved in aqueous solution rather than in air.

Supplementary experiments demonstrated that the ‘flow-through’ fuel cell concept is also valid. A compact mixed-reactant fuel cell was constructed, comprising a stack of electrodes through which the mixture of fuel, oxidant and electrolyte was pumped. Surprisingly, it proved possible to obtain voltages higher than that for a single cell by electrically connecting cells in series. The reason for this is not yet fully understood.

A prototype fuel cell was set up by mounting electrodes between sections of perspex tubing of 5 cm external diameter. The cathode was manganese on a carbon support, on a nickel mesh, with a PTFE binder. The anode was platinum on a carbon support on a nickel mesh, again using a PTFE binder. These electrode materials, and the alkaline system in which they were used, were chosen primarily for their ready availability and for their ease of adaptation to a compact mixed-reactant format.

The fuel cell arrangement is depicted schematically above, showing electrodes sandwiched between perspex tubes. The tubes have inlets and outlets for gas and liquid, and were clamped together using o-ring seals.

Chamber 1 contained fuel, either CH₃OH (5% v/v) or NaBH₄ (varying concentrations) dissolved in 1M KOH, which also acted as the electrolyte. Chamber 2 either contained electrolyte or a mixture of fuel and electrolyte. Chamber 3 contained either air, electrolyte, or fuel and electrolyte. Oxygen was dissolved in the fuel or electrolyte by bubbling air through it.

Curves of current versus voltage were obtained by connecting a variable resistance across the fuel cell. After changing the resistance, the current and voltage were allowed to stabilise for one minute before measurement. In some experiments, particularly with small distances between the electrodes, I and V decreased rapidly with time.

The following passages summarise the experiments carried out and the cell performances obtained.

### 1. Experimental Data

1.1 Initial Experiments

In the initial experiments, the electrodes were 4 cm apart. In the first experiment, cell 1 contained MeOH in KOH, cell 2 contained KOR and cell 3 contained air. In the second experiment MeOH in KOH was used as the electrolyte. Little difference was observed between the two experiments suggesting that the air cathode was selective towards O₂ reduction and did not promote MeOH oxidation.

Towards the end of the set of experiments, KOH and MeOH was used in all three compartments, with O₂ being bubbled through the cell in contact with the cathode. Results were significantly worse than when an air cathode was used, contrary to later observations. This is thought to arise from either the effect of the PTFE backing on the cathode or, more likely, from some ageing effect—the performance of the electrodes appears to deteriorate with time.

In the first set of experiments, the initial open circuit voltage was 0.586V. After the first experiment the open circuit voltage was measured again and was 0.537V.

1.2 Second Fuel Cell Experiment

The aim of this experiment was to compare fuel cells using dissolved oxygen, one of which had MeOH/KOH as the electrolyte, and the other of which had KOH as the electrolyte. Note that the ammeter was used on the A scale, so the resolution of the measurements is 0.001A.

1.3 Effect of Varying Electrode Spacing

All three compartments contained 5% MeOH in 1M KOH, air bubbled through chamber 3. The first experiment (using fresh electrodes) used a 4 cm gap between electrodes, and the open circuit voltage was 0.66V, 1 minute interval between readings. The second experiment used a 1.5 cm gap between electrodes. After the set of experiments the cell was returned to open circuit conditions and the voltage was 0.537V increasing to 0.59V over 15 minutes.

Better performance was expected from the cell with a smaller spacing between electrodes because there would be less resistance to the flow of ions in the electrolyte between the electrodes. Instead, the dominant effect seems to be the consumption of fuel (or possibly formation of K₂CO₃ from the electrolyte) resulting in the power drawn from the cell decreasing over time—this caused the current drawn from the cell to decrease as the resistance decreased.

1.4 First Stack Experiment

A stack of 5 anodes and 5 cathodes was assembled, fed by peristaltic pump, 1M KOH containing 0.104 g NaBH4 in 3G00 ml. Second cell up performed best (first electrodes possibly used before?) but performance fell off over time, as shown below. V open circuit was 0.874V.

With a resistance of 20 Ohms the voltage and current drawn from the cell were measured as a function of time, and a plot of the power produced against time is shown in FIG. 8. After 42 minutes the flow rate was doubled from 0.5 rpm (0.032 ml/s) to 1.0 rpm (0.064 ml/s), causing the power output from the cell approximately to double also.

The open circuit voltage varied across the stack as shown in the table below. Fuel entered the stack at the bottom, so the gradual decrease in voltage going up through the stack can be explained by the consumption of the fuel by some back reaction. The poorer performance of the lowest cell may be due to the fact that all the other electrodes used in the experiment were fresh.

| Electrode | Vopen circuit /V |
|---|---|
| 5 (top) | 0.303 |
| 4 | 0.455 |
| 3 | 0.616 |
| 2 | 0.812 |
| 1 (bottom) | 0.350 (old?) |

When the whole stack was connected in parallel an open circuit voltage of 0.476V was obtained, and the performance of the cell was poor. After this experiment the middle three cells were connected in parallel and the open circuit voltage was 0.288V, indicative of cell component degradation over time.

1.5 Repeated Experiment to Test Mixed Reactant Concept

Because of the suggestion that the cell was degrading over time, the experiments to test the concept of mixed reactants were repeated using fresh electrodes in each experiment. In a first experiment compartment 1 was filled with MeOH/KOH, cell 2 was filled with KOH and cell 3 was filled with air. In a second experiment using fresh solutions and electrodes mixed MeOH/KOH was used in each compartment and air was bubbled through the cathode compartment. As usual, measurements were made at 1 minute intervals.

This time the results showed (FIG. 9) that the mixed reactant cell performed better than the separate compartments, due to methanol on both sides of the anode and/or the higher activity of O₂ in solution compared with in air.

1.6 Second Stack Experiment

The aims of this experiment were to test whether the same performance could be obtained from each cell in the stack, given an excess of fuel and a higher flow-rate, and to test the effect of connecting the individual cells in series and in parallel.

At 5 rpm, 19.08 g of H₂O were delivered in 60s, corresponding to a flow-rate of 0.32 cm³s⁻¹.

Five cells were set up in a vertically-oriented stack. Initially, the lowest three cells were connected in series at 5 rpm and the open circuit voltage obtained was 1.57 V. Each of the three cells was then connected separately, and they gave open circuit voltages of 0.79V (cell 1), 0.83V and 0.83V. When cells 1 and 2 were subsequently connected in series, an open circuit voltage of 1.20V was obtained. When the three were connected in series again, a voltage of 1.41V was obtained, again suggesting component deterioration with time.

The same three cells were also connected in parallel, and the current and voltage across a 20W resistor was measured, as shown below.

| Cell | V/V | I/mA |
|---|---|---|
| 1 | 0.60 | 16.4 |
| 2 | 0.69 | 18.7 |
| 3 | 0.70 | 18.9 |
| 1, 2 and 3 in parallel | 0.755 | 20.3 |

Voltages and currents measured from the three cells independently, and connected in parallel.

In comparison, cell 3 was connected across a 40W resistor so that the voltage was 0.75V, similar to that from the three cells connected in parallel. The resulting current was 13.4 mA. Again, although the three cells connected in parallel gave more power than any individual cell, the current flowing was not three times that produced by any one cell operating independently.

This non-ideal behaviour was attributed to the non-optimised construction of the cells and was not thought to be indicative of an unforeseen electrochemical effect.

### 2. ANALYSIS OF EXPERIMENTAL RESULTS

2.1 Effect of mixing reactants

Curves of voltage against current were measured for a reference cell containing CH₃OH/KOH in chamber 1, KOH in chamber 2, and air in chamber 3. V-I curves were also obtained for a cell containing CH₃OH/KOH with dissolved O₂ in all three chambers. These classic polarisation results are shown in FIG. 9.

Although the power from these alkaline fuel cells is low (as expected for direct-methanol), the above results demonstrate the present inventive concept—i.e. that power can be obtained from a mixed reactant cell. Furthermore, the mixed reactant cell performs better than the cell with separate fuel, electrolyte and oxidant (1.86 mA/cm² at 0.35 volts; peak power=8.4 mW). This could be partly due to having methanol on both sides of the anode, but is also due to the fact that oxygen dissolved in water has a higher activity (0.25) than oxygen in air (0.21) [more likely at open circuit than in a diffusion limited load mode]. These observations confirm that the enhanced performance is attributable to the increase in active surface area at each electrode due to operating in the all-liquid mode.

2.2 Effect of Electrode Spacing

The electrolyte in any fuel cell contributes a resistance to the electrochemical circuit. When a current is drawn from the cell this resistance results in a voltage drop, or polarisation, for the cell. Reducing electrolyte thickness, i.e. the spacing between electrodes results in a corresponding improvement in performance of the cell.

One benefit of the fuel cell according to the present invention is the elimination of one or more of the membranes/structures required to separate fuel from oxidant in the cell, so that electrodes can be placed closer together than in a standard cell. Experiments were performed using the mixed reactant (CH₃OH/KOH/O₂) cell with the distance between electrodes being changed from 4 cm to approximately 1.5 mm to investigate this effect. The results are illustrated in FIG. 6.

Surprisingly, decreasing the electrode spacing from 40 mm to 1.5 mm had minimal effect upon cell performance until a critical level of current was drawn. At this critical point, the power output from the cell decreased suddenly in a time-dependent way.

The region of minimal effect suggests that the performance of the test cell is dominated by factors other than electrolyte resistance. These factors could for example, include electrode polarisation (i.e. the effectiveness of the chosen electrocatalysts).

The sudden drop-off in power at high current was attributed to reactant depletion within the small liquid volume between the electrodes. Although a contribution could also be due to K₂CO₃ formation on the electrodes (i.e. blocking of the electrodes), this reaction between methanol and electrolyte should be more gradual than sudden.

Later experiments, replacing methanol with NaBH₄ fuel, which does not react with the alkaline electrolyte, showed similar behaviour, indicating that K₂CO₃ formation is not a significant factor in this case.

Further experiments utilising higher fuel concentrations and introducing a flow of the reactant mixture and electrolyte through the system according to the invention demonstrated that the sudden power drop-off could be avoided—i.e. that fuel depletion was the most likely cause.

2.3 Compact Stack-Of Fuel Cells

A stack, consisting of 5 pairs of electrodes, was constructed by separating each electrode by a 1.5 mm thick rubber gasket/spacer (annulus with four ‘spokes’ left-in the ‘wheel’ to prevent adjacent electrodes from touching). Multiple pinholes were made in the electrodes to allow the reactant mixture to be slowly pumped through the stack using a peristaltic pump.

2.3.i Low Fuel Concentration & Reactant Flow-Rate

Using NaBH₄ as fuel at a concentration of 0.01 moles dm⁻³, flowing through the stack at 0.032 cm³s⁻¹, gave good results from the cells in the stack that were nearest to the reactant inlet, but the performance (voltage and current) of individual cells in the stack decreased steadily with position in the stack moving further from the inlet. This behaviour was observed under both open circuit conditions (i.e. no current drawn) and when current was drawn.

The open circuit behaviour demonstrated that a direct background reaction between fuel and oxidant is very likely to be occurring in which no electrons are transferred through an external circuit. This reaction could be happening at either electrode, but most likely at the platinum anode. It supports, very strongly, the importance of electrocatalyst selectivity which underlies the inventive fuel cell concept and demonstrates the concept very elegantly.

When power was drawn from cells in the stack, it decreased markedly with time until it levelled off to an approximate steady state. This suggested, as in the previous experiment described above, that fuel was being consumed at a faster rate than it was being replenished.

At ‘steady-state’, the power produced approximately doubled when the flow rate was doubled, again supporting the conclusion that performance was constrained by reactant supply.

2.3.ii High Fuel Concentration and Reactant Flow-Rate

When NaBH₄ fuel was used at a higher (5×) concentration (0.05 M) and much higher (10×) flow rate (0.32 cm³s⁻¹), similar performance was obtained from each of the cells in the stack (previously, performance decreased along the stack in the direction of flow). This result confirmed that the effect of the background reaction between fuel and dissolved oxygen was much less significant than the electrochemical ‘fuel cell’ reaction between the two components. In addition, the proportionately higher power output of this experiment (1.58 mA/cm² at 0.70 volts; power=13.2 mW across 20W resistance) compared to the lower flow rate and concentration (0.74 mA/cm² at 0.29 volts; power=2.58 mW across 20W resistance) again reinforces the link between reactant flow and power output.

2.3.1ii Parallel Stack Performance

Using the 5-cell stack of cells in the high concentration/high flow-rate mode described above, performance of individual cells was compared with multiple connected cells. The three central cells in the stack were connected electrically in both parallel and series modes.

From earlier analysis of the inventive fuel cell concept, parallel mode was originally considered to be the only practicable operating mode of the liquid electrolyte+fuel+oxidant combination. In parallel operation a fuel cell stack is normally expected to operate as a single cell (i.e. single cell voltage) with a total cell area (and therefore total current) equivalent to the sum of the individual cells. In tests of the inventive cell stack, connecting anodes to anodes and cathodes to cathodes for the three central cells, an applied load of 20W gave considerably less than three times the individual cell performance (see table below).

| Cell | V/volts | I/milliamps |
|---|---|---|
| 1 | 0.60 | 16.4 |
| 2 | 0.69 | 18.7 |
| 3 | 0.70 | 18.9 |
| 1, 2 and 3 in parallel | 0.755 | 20.3 |

Voltages and currents measured from the three cells independently, and connected in parallel.

The relative drop-off in performance of the parallel connected stack is not fully understood. One contributory factor may be higher electrical resistance of the parallel connected cells. To compare single cell and parallel performance more directly, the voltage of a single cell (cell 3) was raised by increasing the resistive load on the cell to 40W. With a new single cell voltage of 0.75V (similar to that from the three cells connected in parallel), the resulting current was 13.4 mA. Again, although the three cells connected in parallel give more power than any individual cell, the current output of the parallel stack was still around half that anticipated. Further experiments are required to understand this behaviour.

2.3.iv Series Connected Stack Behaviour

Electrical connections to the three central cells were re-arranged to connect them in series. According to the initial analysis of the system, when connected in series, all but the outer electrodes in a stack of this type should short circuit and therefore give no more voltage or current than a single cell.

Surprisingly, as shown in the table below, when the three cells were connected in series a higher voltage (open circuit) was obtained than that for a single cell. Although the series voltage was less than the sum of the voltages from the three cells operating independently, the result suggests that the inventive system exhibits more complex behaviour than anticipated in the original concept. It may be possible to draw significant power from a simple series connected stack.

| Cell | V/volts |
|---|---|
| 1 (lowest) | 0.79 |
| 2 | 0.83 |
| 3 | 0.83 |
| 1, 2 and 3 in series | 1.57 |

Open circuit voltages from the three cells nearest the mixed reactant feed, and open circuit voltage from the same three cells connected in series.

Although the invention has been particularly described above with reference to specific embodiments, it will be understood by persons skilled in the art that variations and modifications are possible without departing from the scope of the claims which follow.

1. A fuel cell or battery for providing useful electrical power by electrochemical means, comprising:
at least one cell;
at least one anode and at least one cathode within said cell, and ion-conducting electrolyte means for transporting ions between the electrodes;
characterised in that:
fuel, oxidant and said electrolyte means are present as a mixture.

2. A fuel cell or battery as claimed in the preceding claim that utilises the electrode materials both as a surface for the primary cell reactions and as reactants for secondary cell reactions.

3. A fuel cell or battery substantially as described herein with reference to and as illustrated in the accompanying drawings.
